(19) United States
(12) Patent Application Publication
(10) Pub. No.: US 2016/0192278 A1
(43) Pub. Date: Jun. 30, 2016

(54) FAST MULTIPLE BASE STATIONS SEARCH AND ACCESS METHOD AND DEVICE IN WIRELESS COMMUNICATION SYSTEM

(71) Applicant: SAMSUNG ELECTRONICS CO., LTD., Gyeonggi-do (KR)

(72) Inventors: Hyoungju JI, Seoul (KR); Youngbum KIM, Seoul (KR); Seunghoon CHOI, Suwon-si (KR); Younsun KIM, Seongnam-si (KR); Juho LEE, Suwon-si (KR)

(21) Appl. No.: 14/909,346

(22) PCT Filed: Aug. 5, 2014
(86) PCT No.: PCT/KR2014/007213

§ 371 Date: Feb. 1, 2016

(30) Foreign Application Priority Data
Aug. 5, 2013 (KR) 10-2013-0092637

(51) Int. Cl. H04W 48/16; H04W 72/04; H04W 48/20

(52) U.S. Cl. CPC H04W 48/16; H04W 48/20; H04W 72/0446

(57) ABSTRACT

The present invention relates to a method and an apparatus for communication between a terminal and a base station in a wireless communication system. The communication method by a base station according to an embodiment of the present invention may comprise the steps of: transferring, to a terminal connected to the base station and at least one surrounding second base station, information on connection between the second base station and the terminal; transmitting a command for searching the second base station to the terminal; and transmitting a command for transferring a base station connection signal to the terminal. According to an embodiment of the present invention, by a method which enables a terminal to additionally access another base station in a state wherein the terminal is already connected to the base station, the terminal can rapidly search for multiple base stations. Further, the embodiment of the present invention can support access of the terminal to multiple base stations. In addition, on the basis of the method, the terminal can transmit and receive data from multiple base stations.

### TECHNICAL FIELD

Embodiments of the present disclosure relate to a method and apparatus for communication between a terminal and a base station in a wireless communication system and, more particularly, to a method for quickly discovering and accessing any unfound base station in a state where a terminal accesses a certain base station.

Additionally, embodiments of the present disclosure are to simultaneously search for a plurality of base stations and to support a multiple access to found base stations.

### BACKGROUND ART

Normally a mobile communication system has been developed for providing communication and ensuring a user's mobility. With related technologies advanced dramatically, such a mobile communication system reaches a level capable of providing a high-speed data communication service as well as voice communication.

Recently, in 3GPP (3rd Generation Partnership Project), the standardization of LTE-A (Long Term Evolution-Advanced) which is one of next generation mobile communication systems has been carried out. The LTE-A system is now being developed for continuous improvement in performance and realizes a high-speed packet-based communication having a transmission rate which is more than about 3-10 times a currently offered data transmission rate.

Hereinafter, the term LTE system is used as a meaning including the existing LTE system and the LTE-A system.

### DISCLOSURE OF INVENTION

### Technical Problem

In the wireless communication system, a terminal can receive much more data from a nearer base station. Therefore, lots of base stations are required in the wireless communication system. However, according as the number of base stations is increased, a distance between base stations is reduced and also interference is increased. Due to such interference, a terminal may have a poor quality of a received signal and thus fail to receive much more data. In order to reduce interference and prevent the deterioration in quality of a received signal even though many base stations are installed, it is possible for a base station to use no power in case of transmission of no data. However, in this case, a terminal may not usually discover neighboring base stations. The present invention is proposed to meet the aforesaid need and thus provides a terminal with a method for quickly discovering neighboring base stations and then quickly accessing a nearer base station.

The technical problems to be solved by this invention are not limited to those set forth herein, and any other technical problem will be understood by those skilled in the art.

### Solution to Problem

In order to solve the above problem, a communication method of a base station according to an embodiment of the present invention may include steps of delivering, to a terminal connected to the base station and to at least one neighboring second base station, information for a connection between the second base station and the terminal; transmitting a second base station discovery command to the terminal; and transmitting a transmission command of a base station access signal to the terminal.

Additionally, the step of transmitting the transmission command of the base station access signal may include receiving second base station discovery information from the terminal; and transmitting the transmission command of the base station access signal to the terminal by using the received second base station discovery information.

Additionally, the step of transmitting the transmission command of the base station access signal may include receiving, from the terminal, a connection request signal including information about the second base station to be connected by the terminal; and transmitting, to the terminal, the transmission command of the base station access signal for accessing the second base station by using the received connection request signal.

Additionally, the method may further include steps of temporarily allocating a network connection to the at least one second base station; receiving a network connection confirmation message from the second base station which receives the base station access signal from the terminal; receiving, from the terminal, information about a base station which fails to receive the base station access signal; and releasing the temporarily allocated network connection from the base station which fails to receive the base station access signal.

Additionally, the method may further include step of receiving, from the terminal, a further connection result between the terminal and the second base station.

Additionally, the information for a connection between the second base station and the terminal may include identification information about the second base station, discovery signal transmission information of the second base station, identification information about the terminal, and transmission information of the base station access signal of the terminal.

In order to solve the above problem, a communication method of a terminal according to an embodiment of the present invention may include steps of receiving, from a connected first base station, information for a connection between at least one neighboring second base station and the terminal; receiving a discovery signal of the at least one second base station by using the information for a connection between the second base station and the terminal; and transmitting a base station access signal to the at least one second base station by using the information for a connection between the second base station and the terminal.

Additionally, the step of transmitting the base station access signal may include transmitting the discovery signal of the second base station to the first base station; receiving a transmission command of the base station access signal from the first base station; and transmitting the base station access signal to the second base station.

Additionally, the step of transmitting the base station access signal may include transmitting, to the first base station, information about the second base station to be connected by the terminal, by using the discovery signal of the second base station; receiving, from the first base station, a transmission command of the base station access signal for accessing the second base station; and transmitting the base station access signal to the second base station.

Additionally, the step of receiving the discovery signal may include changing a receiver frequency of the terminal; and receiving the discovery signal of the second base station by using the changed frequency.

Additionally, the method may further include step of transmitting, to the first base station, information about the second base station which receives the base station access signal.

Additionally, the method may further include steps of receiving an access response signal from the second base station which receives the base station access signal; transmitting a network access request signal to the second base station which transmits the access response signal; and receiving a network access approval signal from the second base station.

Additionally, if there are two or more of the second base stations, the access response signal may be received from the second base stations through different subframes.

Additionally, if there are two or more of the second base stations, the base station access signal may be transmitted to the second base stations through different subframes, and the access response signal may be received from the second base stations through different subframes.

In order to solve the above problem, a base station according to an embodiment of the present invention may include a communication unit configured to communicate with terminals and neighboring second base stations; and a control unit configured to control delivering, to a terminal connected to the base station and to at least one neighboring second base station, information for a connection between the second base station and the terminal, transmitting a second base station discovery command to the terminal, and transmitting a transmission command of a base station access signal to the terminal.

In order to solve the above problem, a terminal according to an embodiment of the present invention may include a communication unit configured to communicate with second base stations; and a control unit configured to control receiving, from a connected first base station, information for a connection between at least one neighboring second base station and the terminal, receiving a discovery signal of the at least one second base station by using the information for a connection between the second base station and the terminal, and transmitting a base station access signal to the at least one second base station by using the information for a connection between the second base station and the terminal.

### Advantageous Effects of Invention

According to an embodiment of the present disclosure, based on a method for further accessing any other base station in a state of being already accessing a certain base station, a terminal can quickly search for a plurality of base stations and also support a multiple base station access. In addition, a terminal is allowed to transmit or receive data to or from a plurality of base stations.

The effects obtained from this invention are not limited to those set forth herein, and any other effect will be understood by those skilled in the art.

### BRIEF DESCRIPTION OF DRAWINGS

FIG. 1 is a diagram illustrating an example of a communication system transmitting and receiving data between a base station and a terminal.

FIG. 2 is a diagram illustrating the configuration of a downlink subframe in an LTE system according to an embodiment of the present invention.

FIG. 3 is a diagram illustrating the configuration of an uplink subframe in an LTE system according to an embodiment of the present invention.

FIG. 4 is a diagram illustrating an example of a handover method of a terminal according to an embodiment of the present invention.

FIG. 5 is a diagram illustrating an example of a base station access method of a terminal according to an embodiment of the present invention.

FIG. 6 is a diagram illustrating a method for delivering configuration information for a multiple base station access to other base station and to a terminal in advance according to an embodiment of the present invention.

FIG. 7 is a diagram illustrating a base station discovery method of a terminal according an embodiment of the present invention.

FIG. 8 is a diagram illustrating a base station discovery method of a terminal according another embodiment of the present invention.

FIG. 9 is a diagram illustrating a base station discovery method of a terminal according still another embodiment of the present invention.

FIG. 10 is a diagram illustrating a step of performing a network setup for a multiple base station access between base stations according an embodiment of the present invention.

FIG. 11 is a diagram illustrating a step of accessing a found base station at a terminal according an embodiment of the present invention.

FIG. 12 is a diagram illustrating a step of accessing a found base station at a terminal according another embodiment of the present invention.

FIG. 13 is a diagram illustrating a step of accessing a found base station at a terminal according still another embodiment of the present invention.

FIG. 14 is a diagram illustrating an operation of accessing a found base station at a terminal in an FDD system according an embodiment of the present invention.

FIG. 15 is a diagram illustrating an operation of accessing a found base station at a terminal in a TDD system according an embodiment of the present invention.

FIG. 16 is a diagram illustrating an operation of accessing several found base stations at a terminal in an FDD system according an embodiment of the present invention.

FIG. 17 is a diagram illustrating device elements of a base station according to an embodiment of the present invention.

FIG. 18 is a diagram illustrating device elements of a terminal according to an embodiment of the present invention.

### MODE FOR THE INVENTION

Hereinafter, embodiments of the present disclosure will be described with reference to the accompanying drawings.

In this disclosure, some techniques or elements, which are well known in the art or irrelevant to disclosed embodiments, may not be described or illustrated in detail. This is to avoid obscuring the subject matter of the present disclosure.

Additionally, the terms used herein are only used to describe specific various embodiments, and are not intended to limit this disclosure. The present disclosure may be embodied in many different forms and should not be construed as limited to the embodiments set forth herein.

Embodiments of this disclosure relate to a communication system such as the LTE system for transmitting a downlink signal from a base station to a terminal and transmitting an uplink signal from the terminal to the base station. The downlink signal of LTE may include a data channel containing information, a control channel transmitting a control signal, and a reference signal (RS) for a channel measurement and channel feedback. The uplink signal of LTE may include a data channel containing information, a control channel transmitting feedback information or a control signal, and a sounding reference signal (SRS) for measuring a channel of the terminal at the base station.

The LTE base station may transmit data information and control information to the terminal through a physical downlink shared channel (PDSCH) and a downlink control channel (DLCCH), respectively.

The uplink is formed of a data channel, a control channel, and a reference signal, which are transmitted from the terminal and the base station. The data channel may be transmitted through a physical uplink shared channel (PUSCH), and the control channel may be transmitted through a physical uplink control channel (PUCCH).

The LTE base station may have a plurality of reference signals (RSs). These RSs may include one or more of a common reference signal (CRS), a channel state information reference signal (CSI-RS), and a demodulation reference signal (DMRS) or a terminal-dedicated reference signal.

The CRS is transmitted through the entire downlink band and may be used for all terminals in a cell to demodulate a signal and to measure a channel. In order to reduce resources used for CRS transmission, the base station may transmit the DMRS to only a region scheduled for the terminal and, for obtaining channel information, transmit the CSI-RS at the time and frequency axes.

The terminal may transmit the PUSCH and the PUCCH by using the DMRS and transmit the SRS for a channel measurement of uplink. The SRS is transmitted through the final symbol of subframe, and the PUSCH and the PUCCH may not be transmitted simultaneously with the SRS. The PUCCH is transmitted in general at the edge of an uplink bandwidth, and the PUSCH may be transmitted through the entire band.

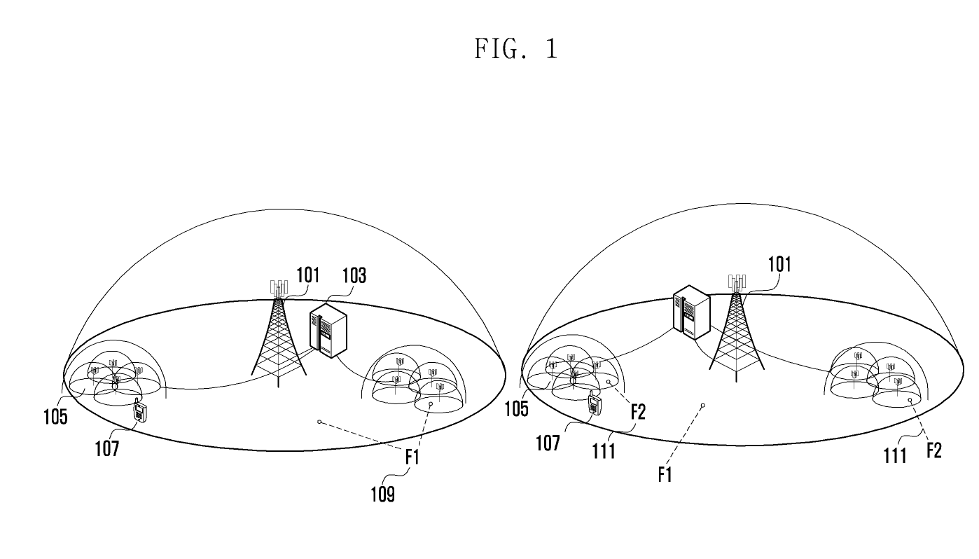

FIG. 1 is a diagram illustrating an example of a communication system transmitting and receiving data between a base station and a terminal.

Referring to FIG. 1, the terminal 107 may access the base station 101 and transmit or receive data to or from a network. The data to be transmitted to the terminal 107 is transmitted from the network to the base station 101, and then the base station 101 schedules radio resources and also transmits the data to the terminal 107. When the terminal 107 moves, the terminal 107 may approach a plurality of other neighboring base stations 105 and deliver this to the base station 101. If the neighboring base stations 105 have a good signal quality, a network controller 103 changes a base station communicating with the terminal 107 to one of the neighboring base stations 105 having a good signal quality. This change may support the terminal to transmit and receive data to and from a single physical base station. This is referred to as handover.

However, in case there are many base stations 101 in the network, a considerable number of base stations 105 are used to increase a data transmission rate of the terminal 107 rather than to ensure cell coverage. Therefore, in case of handover of the terminal 107 to the found neighboring base station 105, the terminal 107 may lose the coverage, while moved, or fail to be really guaranteed a data transmission rate due to frequent handovers. Further, since most of the neighboring base stations 105 maintain a state of stopping the operation until the terminal 107 approaches the base station 105, there is a strong possibility that the terminal 105 will fail to recognize in advance the neighboring base station 105 during movement.

Accordingly, with the coverage from a certain base station 101 guaranteed, the terminal 107 needs a method for obtaining connection with any additional base station 105 for data transmission and reception. Also, proposed is a method for discovering a neighboring base station in a short time and accessing a base station desired by the network.

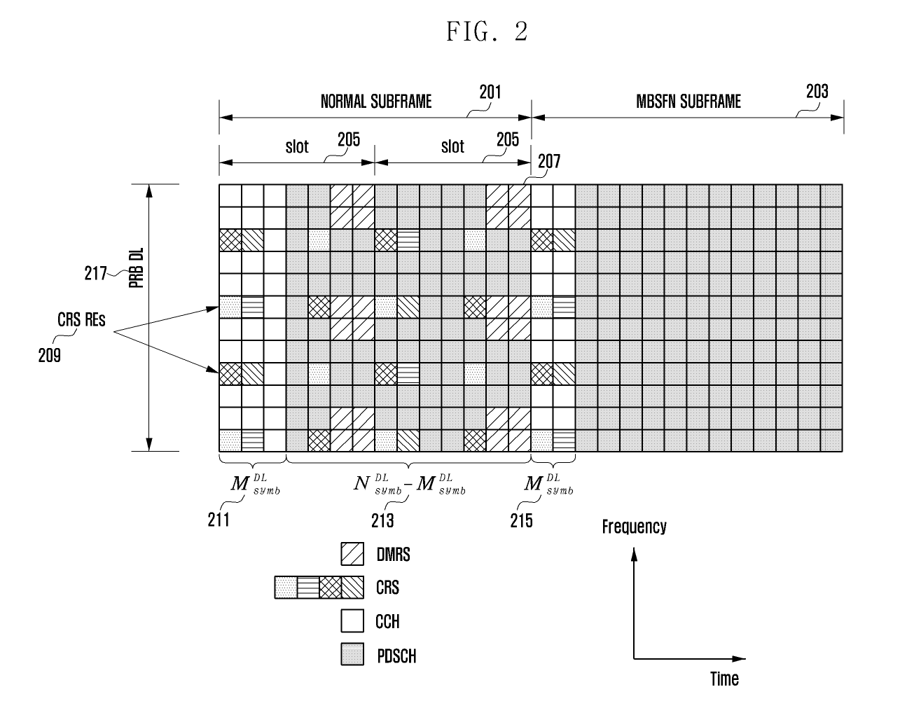

FIG. 2 is a diagram illustrating the configuration of a downlink subframe in an LTE system according to an embodiment of the present invention.

Referring to FIG. 2, the unit of scheduling of the base station is a downlink subframe 201 or 203. A single subframe 201 or 203 is formed of two slots 205 and symbols of N_{symb}^{DL} in total, thereby transmitting a control channel, a data channel, and a reference signal.

Among the symbols of N_{symb}^{DL}, precedent symbols of M_{symb}^{DL} may be used for transmission of a control channel 211, and the other symbols of N_{symb}^{DL}-M_{symb}^{DL} may be used for transmission of a data channel 213.

A transmission bandwidth is formed of resource blocks (RBs) 217 on the frequency axis, and each RB 217 is formed of subcarriers or resource elements (REs) of N_{SC}^{RB} in total. Two slots and a single RB on the time axis are referred to as a PRB pair. In the PRB pair, a common reference signal (CRS) 209, a channel state information-reference signal (CSI-RS), and a demodulation RS (DMRS) 207 are transmitted.

In order to measure a downlink channel, the base station transmits the CRS or the CSI-RS to the terminal. Then the terminal reports a channel measurement result to the base station, so that the base station can know a state of a downlink channel between the base station and the terminal.

Downlink subframes may be classified into a normal subframe 201 and an MBSFN subframe 203 according to their structural features. As indicated by a reference number 215, the MBSFN subframe 203 performs at two precedent symbols the same transmission as the normal subframe 201 and performs no transmission of CRS at the other symbols.

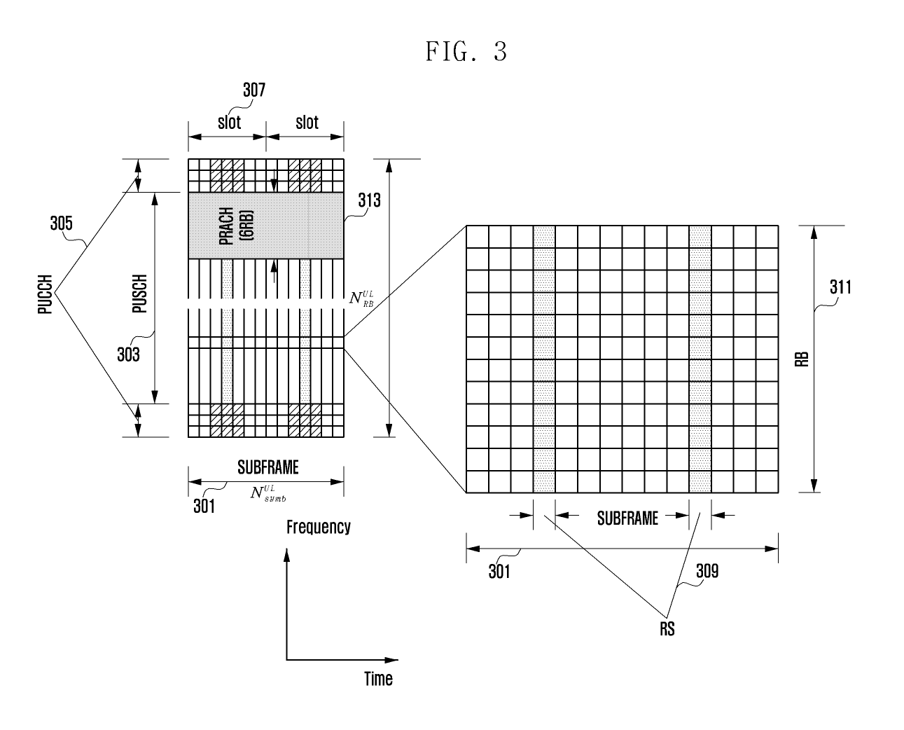

FIG. 3 is a diagram illustrating the configuration of an uplink subframe in an LTE system according to an embodiment of the present invention.

Referring to FIG. 3, the terminal uses an uplink subframe 301 as a basic time unit of transmission. The uplink subframe 301 may be formed of two slots 307. The subframe 301 is formed of, in total, symbols of N_{symb}^{DL} and RBs of N_{RB}^{UL}, and the terminal may transmit a control channel 305, a data channel 303, a reference signal 309, a physical random access channel (PRACH) 313, and the like through such symbols.

The control channel (PUCCH) 305 is transmitted at edges of an uplink band on the frequency axis, and a single PUCCH may be transmitted while alternating both uplink edges in the unit of slot.

By allocating some symbols to DMRS 305 as shown in FIG. 3, the data channel enables the base station to demodulate a signal transmitted from the terminal. The PRACH 313 is transmitted through the data channel region 303 of the subframe 301, having a size of 6 RB on the frequency axis, and using transmittable format from a single subframe to three subframes on the time axis.

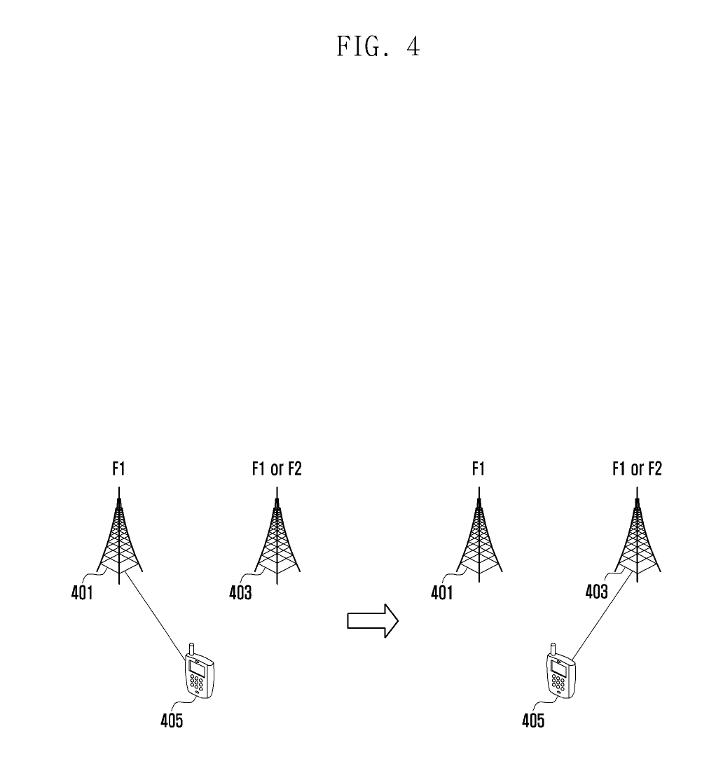

FIG. 4 is a diagram illustrating an example of a handover method of a terminal according to an embodiment of the present invention.

When the terminal 405 changes a cell from the currently connected first base station 401 to the second base station 403, the first base station 401 may determine handover, based on a received signal strength or quality of the second base station 403 measured by the terminal 405. If the terminal 405 determines the handover, the currently connected first base station 401 or a network controller connected with the base station 401 may notify the handover to the neighboring second base station 403 and also instruct the terminal 405 to change a connected base station to the neighboring second base station 403. Then the terminal 405 may transmit and receive data to and from the second base station 403 instead of the first base station 401.

As discussed above, the terminal 405, which is moving, always accesses a single physical base station 401 or 403 for data transmission and reception and should be disconnected from the existing base station 401 so as to be connected with the new base station 403. Additionally, in order to move to the new base station 403, the terminal 405 should deliver in advance, continuously or if necessary, information about a signal quality and a received signal strength regarding the new base station 403 to the connected base station 401. However, this procedure disturbs a quick access to the new base station 403. Besides, in case of requiring much time in communication between base stations, such an issue may be caused more seriously.

In order to solve the above issue, this invention proposes a method for quickly searching for neighboring base stations and accessing such base stations at a terminal.

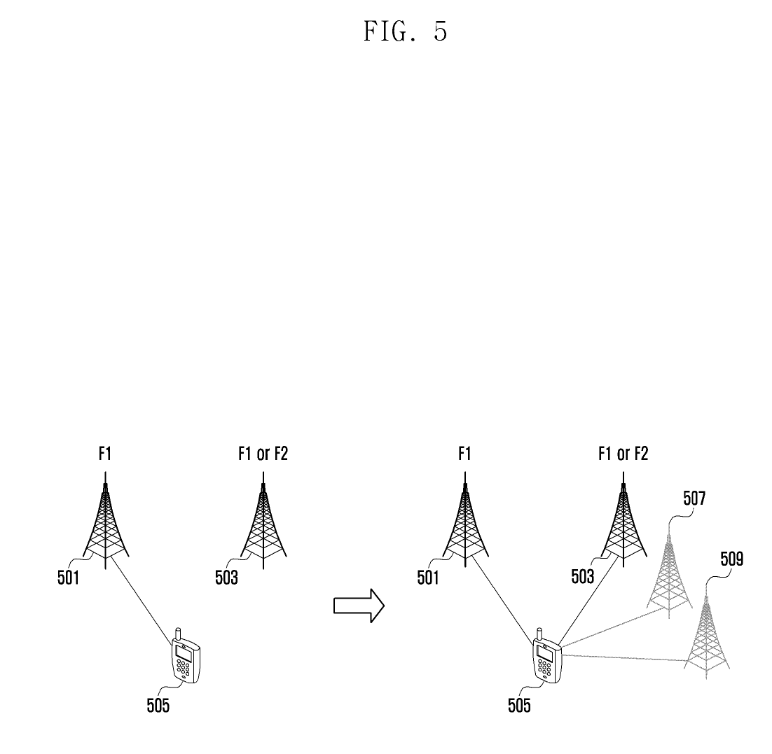

FIG. 5 is a diagram illustrating an example of a base station access method of a terminal according to an embodiment of the present invention.

Referring to FIG. 5, in a base station access method of a terminal proposed by an embodiment of this invention, if the terminal 505 determines that a cell ensures an enough received signal strength or quality from a currently connected, the first, base station 501 to any other, the second, base station 503, the first base station 501 or a network controller connected thereto may determine a multiple access of the terminal 505 and instruct the terminal 505 to access the second base station 503. Then the terminal 505 may receive data from the existing first base station 501 and also transmit and receive data to and from the second base station 503 or any other base station 507 or 509. Further, contrary to FIG. 4 case in which neighboring base stations always transmit a signal for a base station discovery, this embodiment supposes that a base station having no scheduling terminal does not transmit a signal for a base station discovery.

In order to support the above scheme in this embodiment, a step of delivering configuration information to a base station and a terminal in advance, a step of discovering neighboring base stations at a terminal, a step of performing a network setup, and a step of accessing a found base station will be described hereinafter.

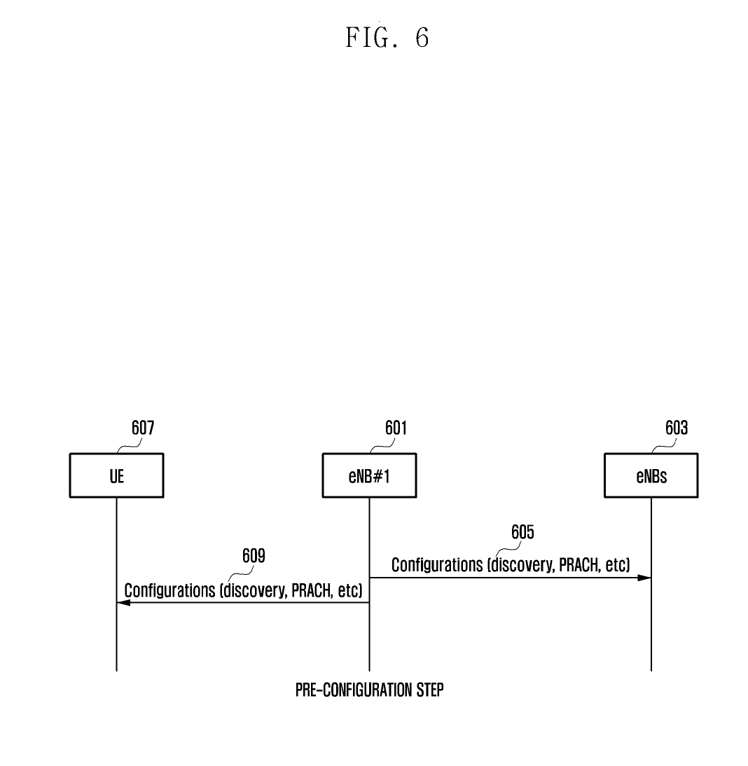

FIG. 6 is a diagram illustrating a method for delivering configuration information for a multiple base station access to other base station and to a terminal in advance according to an embodiment of the present invention.

Referring to FIG. 6, the terminal 607 (also referred to as user equipment (UE) or the like) accesses the first base station 601 (also referred to as evolved Node B (eNB) or the like) and transmits or receives data to or from a network. The first base station 601 delivers scheduling information to the terminal 607 and instructs data transmission and reception. In this case, for supporting any additional base station connection of the terminal 607, the first base station 601 should deliver, in advance, configuration information for access to both the terminal 607 and the at least one second base station 603 connected to or existing near the first base station 601. At step 605, the first base station 601 may deliver, to at least one, neighboring, the second base station 603, a message including, at least, configuration information for a base station discovery, configuration information required for PRACH transmission of the terminal 607, and the like. Also, at step 609, the first base station 601 may deliver, to the terminal 607 for an additional base station connection, a message including configuration information for a base station discovery, configuration information required for PRACH transmission of the terminal 607, and the like.

Here, the configuration information for a base station discovery, transmitted to the at least one second base station 603 neighboring on the first base station 601 at step 605, may include, at least, time information and transmission power information in connection with transmission of a base station discovery signal having to be transmitted by the second base station 603. This time information may include, at least, information in the unit of a system frame and subframe based on timing of the transmitting base station. The discovery signal for a base station discovery is a signal transmitted by the base station 603 at any time. The discovery signal enables the terminal 607 to identify respective individual base stations 603 transmitting the signal and to obtain time and frequency synchronization of the base stations 603 simultaneously transmitting the discovery signal. In an embodiment of this invention, the discovery signal may use a reference signal and a synchronization signal in LTE and may also include all signals performing similar functions. Additionally, the configuration information transmitted at step 605 may include information about a discovery signal transmission length and this may be represented as information indicating transmission of a certain preconfigured subframe length on the basis of the transmission time.

The configuration information required for PRACH transmission of the terminal 607, transmitted to the at least one second base station 603 neighboring on the first base station 601 at step 605, may include, at least, sequence and mask information of PRACH transmitted by the terminal 607. This information is used by the second base station 603 to identify PRACH transmitted from each terminal 607. Also, the configuration information required for PRACH transmission may include information about a frequency region for PRACH transmission, information about a format of PRACH, and the like. The frequency region information refers to channel information of PRACH, and the format information refers to information for identifying a time length of PRACH. The reception time of PRACH may be considered as subframe occurring after k pieces of subframes from the transmission time of a discovery signal. In an embodiment, k is information about a time point when the terminal 607 actually transmits PRACH after receiving instructions for PRACH transmission, and this may occur in general after six subframes.

The configuration information for a base station discovery, transmitted to the terminal 607 at step 609, may include, at least, a length of a discovery signal transmitted by the base station, and the like. Additionally, the configuration information for PRACH transmission, transmitted to the terminal 607 at step 609, may include, at least, PRACH format information, PRACH transmission power information, PRACH frequency region information, and the like.

Therefore, the second base station 603 that receives configuration information at step 605 transmits a signal for a base station discovery based on discovery signal information contained in the received configuration information, and the first base station 601 may select the second base station 603 accessible by the terminal 607 by selecting the second base station 603 to which the configuration information is delivered at step 605. Also, it is possible to enable the terminal 607 to selectively access a number of base stations depending on loading conditions of network or base stations. Further, it is possible to regulate the coverage of the second base station 603 through transmission power information of a discovery signal. Meanwhile, the configuration information transmitted to the terminal at step 609 may allow the terminal 607 to control transmission power of PRACH, thereby regulating a distance of the second base station 603 capable of receiving PRACH from the terminal 607.

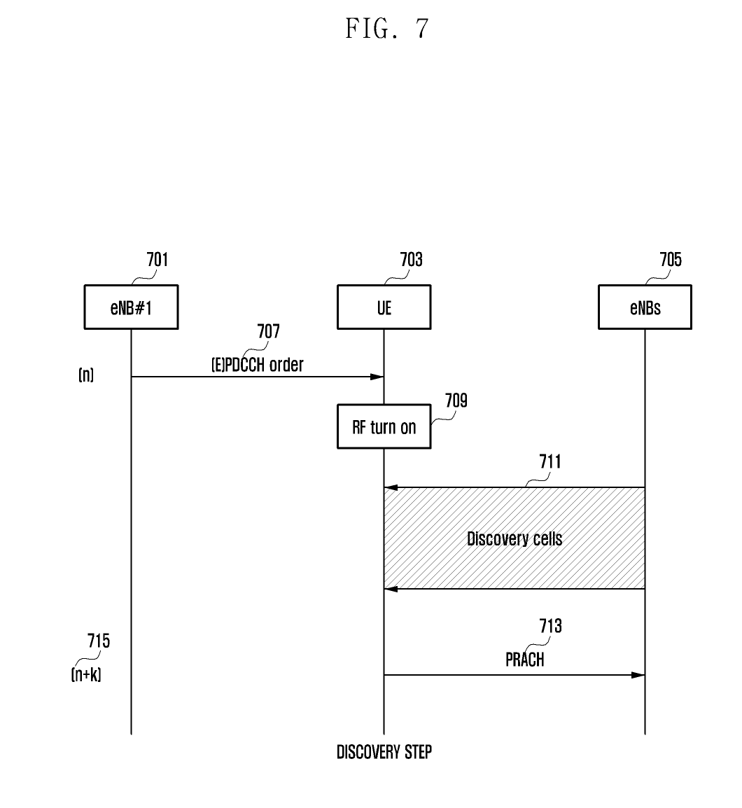

FIG. 7 is a diagram illustrating a base station discovery method of a terminal according an embodiment of the present invention.

Referring to FIG. 7, the terminal 703 may receive, from the first base station 701 through a control channel 707, instructions about discovery 711 of the second base station 705 and about PRACH transmission 713. Then the terminal 703 may simultaneously perform a search for a discovery signal on downlink and PRACH transmission on uplink. Namely, the first base station 701 enables the terminal 703 to simultaneously perform a search and PRACH transmission when the accessible second base station 705 transmits a discovery signal. Therefore, if there is the second base station 705 that can be connected to the terminal 703, the terminal may quickly try to access the second base station 705 with reduced discovery and access time.

Specifically, the terminal 703 can perform a base station discovery and PRACH transmission, based on preconfigured information. An actual base station discovery and PRACH transmission of the terminal 703 may be performed through a control channel transmitted to the terminal by the base station 701 at step 707. This control channel may include, at least, mask information and sequence information for PRACH transmission. Namely, using such information, the terminal 703 can perform PRACH transmission.

Depending on an embodiment, if a frequency band of the second base station 705 to be further accessed is different from a frequency band of the first base station 701 currently accessed by the terminal 703, the terminal 703 may be not using its RF device for receiving a signal of the second base station 705. Also, if there is no accessing terminal, the second base station 705 may maintain a state of not using its RF device. Therefore, when the terminal 703 receives a control channel for discovery of the second base station 705 from the first base station 701 at step 707, the terminal 703 may turn on its RF device at step 709 so as to receive a signal from the second base station 705.

Thereafter, at step 711, the terminal 703 may receive a discovery signal from the second base station 705. Simultaneously, the terminal 703 prepares PRACH transmission on uplink and may transmit PRACH to an uplink band used by the second base station 705 on the basis of subframe of the first base station 701 accessed by the terminal 703. By the way, since a base station discovery is not actually completed at step 711 while the terminal 703 prepares PRACH transmission, the terminal 703 transmits PRACH toward unspecified base stations rather than toward a discovered specific base station. At this time, the second base stations 705 may try to receive PRACH transmitted by the terminal 703, based on preconfigured PRACH information. This embodiment proposes a method in which the terminal 703 tries to access a base station by transmitting PRACH to a number of preconfigured, unspecified base stations in a state where the terminal 703 does not finish a base station discovery. Therefore, after a base station discovery is finished, the terminal 703 can prevent a time loss due to transmission of PRACH and quickly try to access another base station. When transmitting PRACH to a number of unspecified base stations 705, the terminal 703 may transmit PRACH on the basis of timing of the first base station 701 accessed by the terminal 703 because of no completion of a base station discovery. The time point when the terminal 703 transmits PRACH may occur after k pieces of subframes 715 from the reception of a control channel at step 707. This may be, for example, the sixth or the earliest uplink PRACH resource region after the sixth.

At step 711 of performing a base station discovery, the terminal 703 may receive a discovery signal and identify a base station. Also, the terminal 703 may obtain time and frequency synchronization regarding the identified second base station 705 and store this in a memory thereof. The single terminal 703 can identify at least one base station and also obtain and store information about time and frequency synchronization regarding the identified base station. If the received discovery signal has a very poor quality, the terminal 703 may obtain no information.

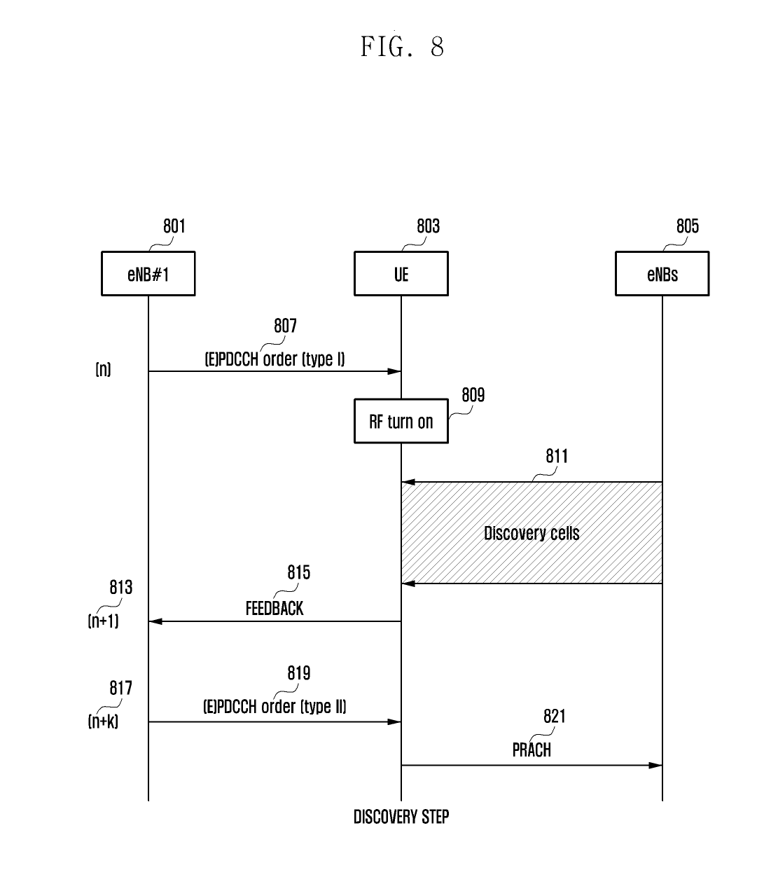

FIG. 8 is a diagram illustrating a base station discovery method of a terminal according another embodiment of the present invention.

Referring to FIG. 8, the terminal 803 may receive signaling for discovery 811 of the second base station 805 through a control channel 807 from the first base station 801 and also receive signaling for PRACH transmission 821 through a control channel 819. In order to differentiate these two signals, the terminal 803 may receive signaling for second base station discovery and signaling for PRACH transmission through different control channels 807 and 819, or may be instructed through identifiers for differentiating between second base station discovery and PRACH transmission at the same control channel. Also, the terminal 803 may selectively perform a search for a discovery signal on downlink and PRACH transmission on uplink. Through this, the base station may differentiate discovery for accessible base stations from access to such base stations. Further, by continuously instructing the terminal 803 on discovery, an effective selection of a base station to be accessed is possible.

Specifically, the terminal 803 can perform a base station discovery and PRACH transmission, based on preconfigured information. An actual base station discovery and PRACH transmission of the terminal 803 may be performed through different control channels transmitted by the first base station 801 at steps 807 and 819. Depending on an embodiment, a control channel for a base station discovery transmitted at step 807 and a control channel for PRACH transmission transmitted at step 819 may use the same control channel. In this case, information of a control channel may use identifiers for differentiating two functions, and if an information field for PRACH transmission is a specific filed, this may be considered as indicating a base station discovery. According to another method, even though the same control channel is used, it is possible to recognize different control channels through CRC descrambling using different kinds of information. The control channel for PRACH transmission transmitted at step 819 may include, at least, mask information and sequence information for PRACH transmission. Namely, using such information, the terminal 803 can perform PRACH transmission.

Depending on an embodiment, if a frequency band of the second base station 805 to be further accessed is different from a frequency band of the first base station 801 currently accessed by the terminal 803, the terminal 803 may be not using its RF device for receiving a signal of the second base station 805. Also, if there is no accessing terminal, the second base station 805 may maintain a state of not using its RF device. Therefore, when the terminal 803 receives a control channel for discovery of the second base station 805 from the first base station 801 at step 807, the terminal 803 may turn on its RF device at step 809 so as to receive a signal from the second base station 805.

Thereafter, at step 811, the terminal 803 may receive a discovery signal from the second base station 805. Then, at step 815, the terminal 803 may feed discovered information back to the first base station 801. Simultaneously, the terminal 803 may store, in a memory, time and frequency synchronization information of the discovered second base station 805 and information of the identified second base station 805.

Thereafter, if there is any base station accessible by the terminal 803 among the second base stations 805, the first base station 801 may instruct the terminal 803 on PRACH transmission through a control channel. Then the terminal 803 prepares PRACH transmission on uplink and may transmit PRACH to an uplink band used by the second base station 805 on the basis of subframe of the first base station 801 accessed by the terminal 803. Alternatively, transmission may be performed on the basis of subframe of the nearest second base station 805 discovered by the terminal 803, or the first base station 801 may instruct PRACH transmission to a specific base station among discovered base stations. Such information may be contained in a control channel transmitted to the terminal 803 at step 819, or PRACH transmission sequence or mask may be instructed in advance through upper signaling.

This embodiment associated with FIG. 8 proposes a method in which the terminal discovers base stations in advance and, only in case of need, performs PRACH transmission for an actual access. In the previous embodiment associated with FIG. 7, the terminal should always transmit PRACH when the first base station instructs the terminal on a control channel. However, this embodiment associated with FIG. 8 has the merit of selectively performing PRACH transmission at the terminal.

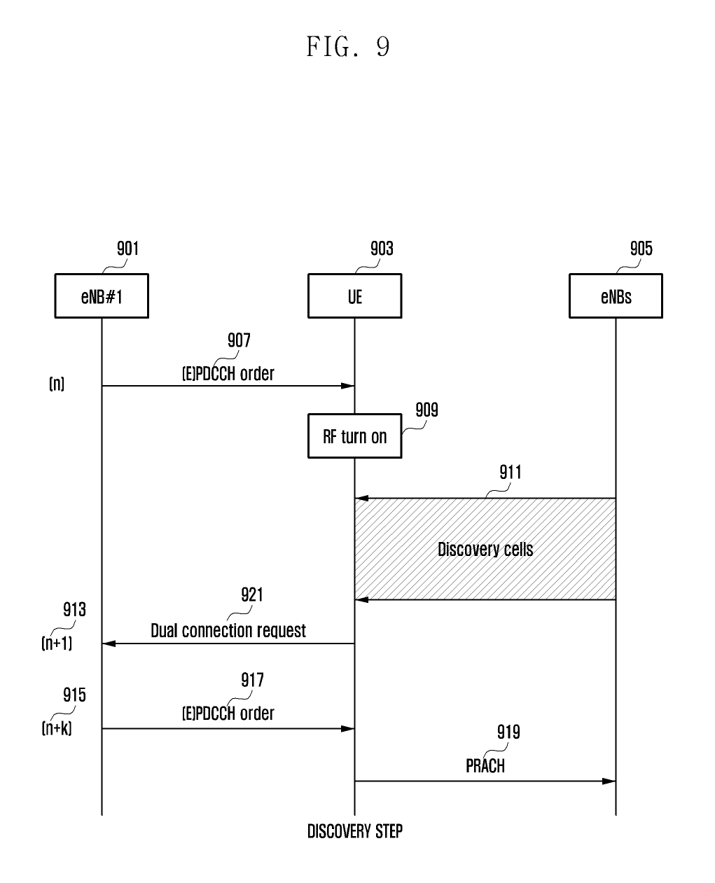

FIG. 9 is a diagram illustrating a base station discovery method of a terminal according still another embodiment of the present invention.

Referring to FIG. 9, the terminal 903 may receive signaling for discovery 911 of the second base station 905 through a control channel 907 from the first base station 901. Then, if it is determined that there is a base station requiring connection among discovered base stations, the terminal 903 may transmit a multiple access request signal 921 to the first base station 901. Also, in response to the multiple access request signal 921, the first base station 901 may transmit signaling for PRACH transmission 919 through a control channel 917. In order to differentiate a signal for base station discovery and a signal for PRACH transmission, the terminal 903 may receive signaling for second base station discovery and signaling for PRACH transmission through different control channels 907 and 917, or may be instructed through identifiers for differentiating between second base station discovery and PRACH transmission at the same control channel. Also, the terminal 903 may selectively perform a search for a discovery signal on downlink and PRACH transmission on uplink. Through this, the terminal 903 may try to access the second base station, based on the access request 921, without receiving any unnecessary access request, thus preventing power consumption of the terminal 903.

Specifically, the terminal 903 can perform a base station discovery and PRACH transmission, based on preconfigured information. An actual base station discovery and PRACH transmission of the terminal 903 may be performed through different control channels transmitted by the first base station 901 at steps 907 and 917. Depending on an embodiment, a control channel for a base station discovery transmitted at step 907 and a control channel for PRACH transmission transmitted at step 917 may use the same control channel. In this case, information of a control channel may use identifiers for differentiating two functions, and if an information field for PRACH transmission is a specific filed, this may be considered as indicating a base station discovery. According to another method, even though the same control channel is used, it is possible to recognize different control channels through CRC descrambling using different kinds of information. The control channel for PRACH transmission transmitted at step 917 may include, at least, mask information and sequence information for PRACH transmission. Namely, using such information, the terminal 903 can perform PRACH transmission.

Depending on an embodiment, if a frequency band of the second base station 905 to be further accessed is different from a frequency band of the first base station 901 currently accessed by the terminal 903, the terminal 903 may be not using its RF device for receiving a signal of the second base station 905. Also, if there is no accessing terminal, the second base station 905 may maintain a state of not using its RF device. Therefore, when the terminal 903 receives a control channel for discovery of the second base station 905 from the first base station 901 at step 807, the terminal 903 may turn on its RF device at step 909 so as to receive a signal from the second base station 905.

Thereafter, at step 911, the terminal 903 may receive a discovery signal from the second base station 905. Then, if there is any base station accessible by the terminal 903 among the discovered base stations, the terminal 903 may feed related information back to the first base station 901 at step 921. This is referred to as a connection request signal. Simultaneously, the terminal 903 may store, in a memory, time and frequency synchronization information of the discovered second base station 905 and information of the identified second base station 905. The terminal 903 may transmit the connection request signal to the first base station 901 by using PUCCH format1 defined in LTE, and resources may be allocated in advance to the terminal 903 through upper signaling. The PUCCH format1 is a method for transmitting energy to corresponding resources when 1-bit information is determined as positive information. If it is determined as negative, no transmission is performed.

Thereafter, if there is a connection request from the terminal 903, the first base station 901 may instruct the terminal 903 on PRACH transmission through a control channel at step 917. Then, at step 919, the terminal 903 may prepare PRACH transmission on uplink and may transmit PRACH to an uplink band used by the second base station 905 on the basis of subframe of the first base station 901 accessed by the terminal 903.

This embodiment associated with FIG. 9 proposes a method in which the terminal discovers base stations in advance and gives feedback to the first base station 901 regarding whether to access the second base station. Therefore, PRACH transmission is performed only in case of need. In the previous embodiments associated with FIGS. 7 and 8, the terminal should always transmit PRACH or deliver information about a number of discovered base stations when the first base station instructs the terminal on a control channel. However, this embodiment associated with FIG. 9 has the merit of instructing a base station access with lower overhead.

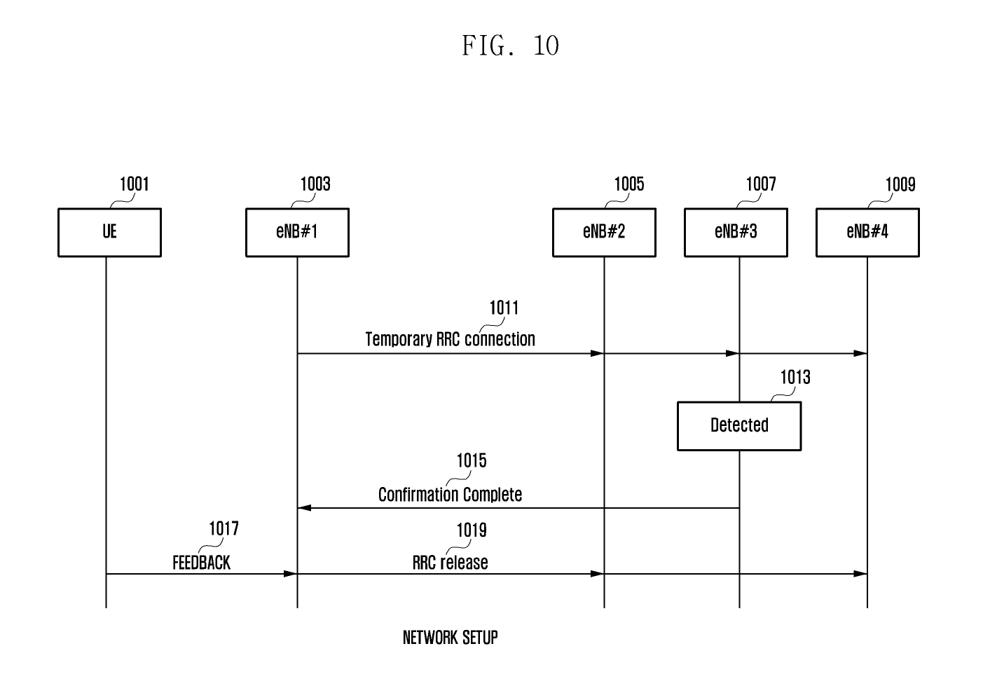

FIG. 10 is a diagram illustrating a step of performing a network setup for a multiple base station access between base stations according an embodiment of the present invention.

Referring to FIG. 10, base stations are normally connected to each other over wires. Such a wired connection is very slow and this actually causes an increasing delay to the terminal according as an exchange of information occurs frequently. Therefore, in order to obviate this problem, a network setup method as shown in FIG. 10 may be applied to the present invention.

In a proposed embodiment, the first base station 1003 accessed by the terminal 1001 may allocate a temporary RRC connection, which allows a network to transmit data of the terminal 1001, to other base stations 1005, 1007 and 1009 at step 1011 before requesting PRACH transmission from the terminal 1001 for connections with other base stations 1005, 1007 and 1009. Thereafter, if the third base station 1007 receives PRACH from the terminal 1001 and approves access at step 1013, the third base station 1007 may complete a temporary connection by confirming the temporary RRC connection to the first base station 1001 at step 1015. Then, at step 1017, the terminal 1001 may ascertain a connection of the third base station 1007 after PRACH transmission and deliver information about unconnected, the second and fourth base stations 1005 and 1009 to the first base station 1003. Then, at step 1019, the first base station 1003 may release the RRC connection temporarily allocated to the second and fourth base stations 1005 and 1009. Depending on an embodiment, at step 1017, the terminal 1001 may give feedback to the first base station 1003 regarding information about the connected third base station 1007 as well as information about the unconnected second and fourth base stations 1005 and 1009. Then, at step 1019, the first base station 1003 may maintain or release the preconfigured RRC connection without using communication between base stations.

According to this proposed embodiment, the terminal 1001 tries a connection with base stations 1005, 1007 and 1009 other than the already connected first base station and then gives feedback to the first base station 1003 regarding information about a connection try. Therefore, even in a network having a long delay of communication between base stations, multiple base station access is possible.

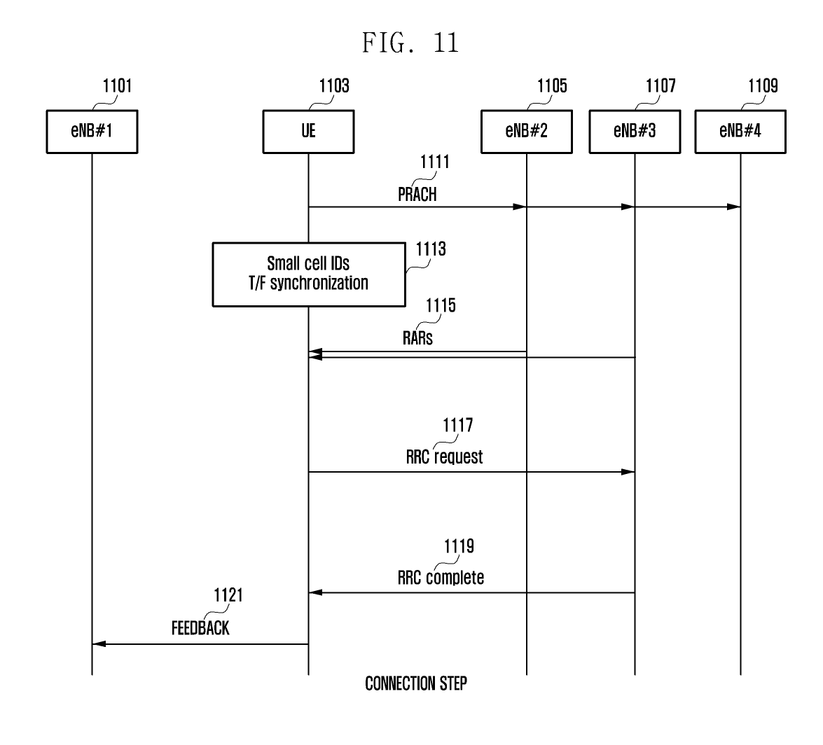

FIG. 11 is a diagram illustrating a step of accessing a found base station at a terminal according an embodiment of the present invention.

Referring to FIG. 11, in a base station access method according to an embodiment of this invention, the terminal 1103 may transmit a single PRACH 1111 to a plurality of unspecified base stations 1105, 1107 and 1109 and then receive a response signal 1115 from some base stations 1105 and 1107.

Specifically, the terminal 1103 that receives a control channel for PRACH transmission from the currently connected first base station 1101 may transmit, at step 1111, PRACH on uplink of a frequency band in which discovery is performed. For example, if the first base station 1101 notifies in advance a resource for PRACH reception to the second, third and fourth base stations 1105, 1107 and 1109, these base stations 1105, 1107 and 1109 may try to receive PRACH from the terminal 1103.

Thereafter, the base stations 1105 and 1107 that successfully receive PRACH transmit a random access response (RAR) regarding PRACH transmission to the terminal 1103. At step 1113, the terminal 1103 may try to receive time and frequency synchronization by using base station discovery information stored in a memory thereof and also receive RAR by using a base station identifier. If the second and third base stations 1105 and 1107 successfully receive PRACH from the terminal 1103, each of the second and third base stations 1105 and 1007 transmits RAR at step 1115. At this time, the terminal 1103 may try to receive RAR by using base station discovery information stored in the memory thereof. In an embodiment, the terminal 1103 may receive RAR from a selected base station corresponding to the greatest strength or best quality of a received signal by considering base station discovery information. In another embodiment, the terminal 1103 may try to receive RAR from all base stations corresponding to a specific received signal quality or more or specific received signal power or more. Alternatively, the terminal 1103 may try to receive RAR from all base stations.

When successfully receiving RAR, the terminal 1103 may obtain information from the received RAR. Information in RAR transmitted by the base stations 1105, 1107 and 1109 may include a specific ID of the terminal 1103 or a specific cell ID of the base station with regard to PRACH transmitted by the terminal 1103. The specific ID of the terminal 1103 may be contained to distinguish the terminal 1103 from other terminal using the same PRACH sequence. The specific cell ID of the base station may be contained to prevent different base stations from actually using the same cell ID.

When successfully receiving RAR, the terminal 1103 may transmit a request for creating a data channel to the corresponding base station at step 1117. In an embodiment, based on RAR regarding the base station corresponding to base station discovery information stored in a memory, the terminal 1103 may transmit a request for a data channel to the corresponding base station. For example, the terminal 1103 may store, in the memory thereof, base station discovery information regarding the third and fourth base stations 1107 and 1109. In this case, if the second and third base stations 1105 and 1107 transmit RARs, the terminal 1103 may transmit a request for a data channel to the third base station 1107 at step 1117 according to RAR transmitted by the third base station 1107.

Thereafter, at step 1119, the base station may allow data channel transmission and reception together with a response to the request. Then, at step 1121, the terminal 1103 may notify the result of additional base station access to the first base station 1101.

In this case, using identification information about at least one base station and time and frequency synchronization information obtained at the base station discovery step, the terminal 1103 may receive a response signal regarding PRACH transmission from the plurality of base stations 1105, 1107 and 1109, and then perform a data channel request with regard to at least one base station. In an embodiment, the terminal 1103 may receive a response signal regarding PRACH transmission from only a base station corresponding to the best received signal performance by considering the obtained base station discovery information. In this case, the terminal 1103 may require a data channel of a single base station. If the terminal 1103 discovers the plurality of base stations 1105, 1107 and 1109, the terminal 1103 may receive a response channel with regard to PRACH transmission from the base stations 1105, 1107 and 1109 and also require data channel connections of the base stations 1105, 1107 and 1109.

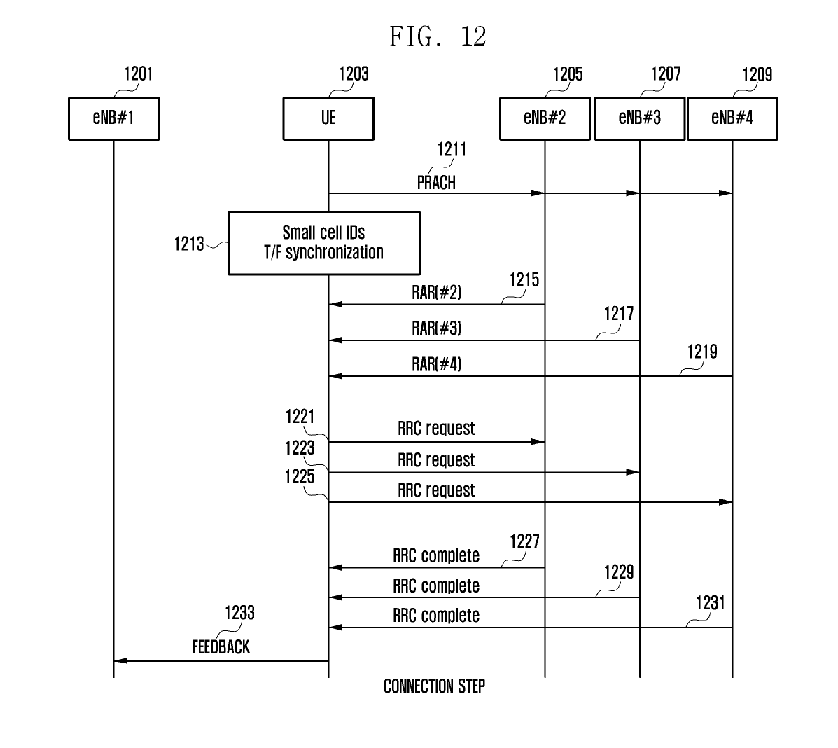

FIG. 12 is a diagram illustrating a step of accessing a found base station at a terminal according another embodiment of the present invention.

Referring to FIG. 12, in a base station access method according to an embodiment of this invention, the terminal 1203 may transmit a single PRACH 1211 to a plurality of unspecified base stations 1205, 1207 and 1209 and then receive response signals 1215, 1217 and 1219 from the base stations 1205, 1207 and 1209 through different subframes. Therefore, the terminal 1203 may simultaneously access the plurality of base stations.

Specifically, the terminal 1203 that receives a control channel for PRACH transmission from the currently connected first base station 1201 may transmit, at step 1211, PRACH on uplink of a frequency band in which discovery is performed. For example, if the first base station 1201 notifies in advance a resource for PRACH reception to the second, third and fourth base stations 1205, 1207 and 1209, these base stations 1205, 1207 and 1209 may try to receive PRACH from the terminal 1203.

Depending on an embodiment, the format of PRACH may be formed of at least three subframe lengths, and the respective base stations 1205, 1207 and 1209 may be instructed to receive PRACH through different subframes. In this case, the base stations 1205, 1207 and 1209 that successfully receive PRACH may transmit a random access response (RAR) regarding PRACH transmission to the terminal 1203 through different subframes at steps 1215, 1217 and 1219. At step 1213, the terminal 1203 may try to receive time and frequency synchronization by using base station discovery information stored in a memory thereof and also receive RAR by using a base station identifier. Since the base stations 1205, 1207 and 1209 receiving PRACH transmit RARs through different subframes at steps 1215, 1217 and 1219, no interference is caused. Therefore, using the base station discovery information stored therein, the terminal 1203 may receive RAR through each subframe.

When successfully receiving RAR, the terminal 1203 may obtain information from the received RAR. Information in RAR transmitted by the base stations 1205, 1207 and 1209 may include a specific ID of the terminal 1203 or a specific cell ID of the base station with regard to PRACH transmitted by the terminal 1203. The specific ID of the terminal 1203 may be contained to distinguish the terminal 1203 from other terminal using the same PRACH sequence. The specific cell ID of the base station may be contained to prevent different base stations from actually using the same cell ID.

When successfully receiving RAR, the terminal 1203 may transmit a request for creating a data channel to the corresponding base stations 1205, 1207 and 1209 through different subframes at steps 1221, 1223 and 1225.

Thereafter, at steps 1227, 1229 and 1231, each of the base stations 1205, 1207 and 1209 may respond to the request and also allow all cells successfully receiving PRACH to transmit and receive a data channel. Then, at step 1233, the terminal 1203 may notify the result of additional base station access to the first base station 1201. Also, for example, data channels may be received from four base stations, i.e., the first, second, third and fourth base stations 1201, 1205, 1207 and 1209.

In this case, using identification information about at least one base station and time and frequency synchronization information obtained at the base station discovery step, the terminal 1203 may receive a response signal regarding PRACH transmission from the plurality of base stations 1205, 1207 and 1209 through different subframes, and then perform a data channel request with regard to at least one base station. Since the terminal 1203 transmits PRACH to the unspecified, plurality of base stations 1205, 1207 and 1209, the PRACH format may be configured to transmit PRACH through one or more subframes for effective PRACH reception. In this case, the base stations 1205, 1207 and 1209 may receive PRACH through different subframes. Also, the base stations 1205, 1207 and 1209 may configure in advance different subframes for receiving PRACH. Therefore, the plurality of base stations 1205, 1207 and 1209 receiving PRACH may transmit RARs to the terminal 1203 at different times, and the terminal 1203 has the merit of capable of performing different requests for data channels at different times.

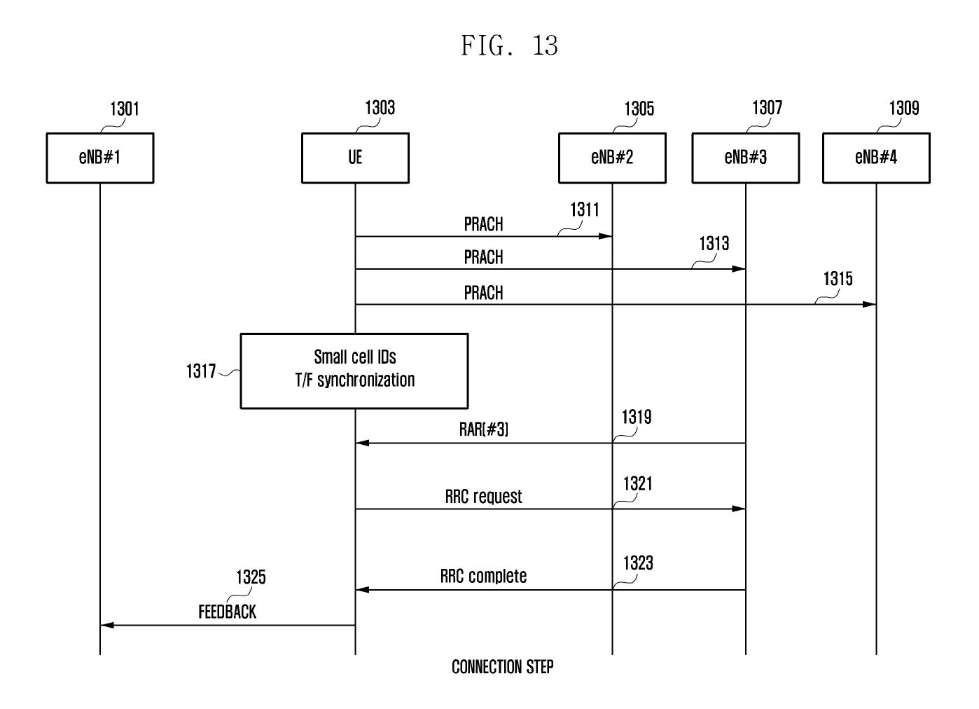

FIG. 13 is a diagram illustrating a step of accessing a found base station at a terminal according still another embodiment of the present invention.

Referring to FIG. 13, in a base station access method according to an embodiment of this invention, the terminal 1303 may transmit at least one PRACH 1311 to a plurality of unspecified base stations 1305, 1307 and 1309 through different subframes and then receive at least one response signal 1319 from the at least one base station 1307 through different subframes. Therefore, the terminal 1303 may access the base station.

Specifically, the terminal 1303 that receives a control channel for PRACH transmission from the currently connected first base station 1301 may transmit, at steps 1311, 1313 and 1315, PRACHs of different sequences through continuous subframes on uplink of a frequency band in which discovery is performed. For example, if the first base station 1301 notifies in advance sequences for PRACH reception to the second, third and fourth base stations 1305, 1307 and 1309, these base stations 1305, 1307 and 1309 may try to receive corresponding PRACH among PRACHs 1311, 1313 and 1315 transmitted from the terminal 1303.

In case the base stations 1305, 1307 and 1309 successfully receive PRACH through different subframes, these base stations 1305, 1307 and 1309 may transmit a random access response (RAR) regarding PRACH transmission to the terminal 1303 through different subframes at step 1319. At step 1317, the terminal 1303 may try to receive time and frequency synchronization by using base station discovery information stored in a memory thereof and also receive RAR by using a base station identifier.

When successfully receiving RAR from the third base station 1307 at step 1319, the terminal 1303 may obtain information from the received RAR. Information in RAR transmitted by the base stations 1305, 1307 and 1309 may include a specific ID of the terminal 1303 or a specific cell ID of the base station with regard to PRACH transmitted by the terminal 1303. The specific ID of the terminal 1303 may be contained to distinguish the terminal 1303 from other terminal using the same PRACH sequence. The specific cell ID of the base station may be contained to prevent different base stations from actually using the same cell ID.

When successfully receiving RAR, the terminal 1303 may transmit a request for creating a data channel to the corresponding base station 1307 at step 1321.

Thereafter, at step 1323, the base station 1307 may respond to the request and also allow all cells successfully receiving PRACH to transmit and receive a data channel. Then, at step 1325, the terminal 1303 may notify the result of additional base station access to the first base station 1301.

In this case, using identification information about at least one base station and time and frequency synchronization information obtained at the base station discovery step, the terminal 1303 may transmit different PRACHs to the plurality of base stations 1305, 1307 and 1309 through different subframes, and then receive at least one response signal. Therefore, this is a method for performing a data channel request with regard to one or more base stations 1305, 1307 and 1309. Since the terminal 1303 transmits different PRACHs to specific base stations rather than to a plurality of unspecified base stations, the respective PRACHs are transmitted through different subframes for PRACH reception. In this case, the base stations 1305, 1307 and 1309 may receive PRACHs through different subframes. Also, sequence or mask information of PRACH for each of the base stations 1305, 1307 and 1309 may be configured in advance differently according to the base stations 1305, 1307 and 1309. Therefore, the plurality of base stations 1305, 1307 and 1309 respectively receiving PRACHs may transmit RARs to the terminal 1303 at different times, and the terminal 1303 has the merit of capable of performing different requests for data channels at different times.

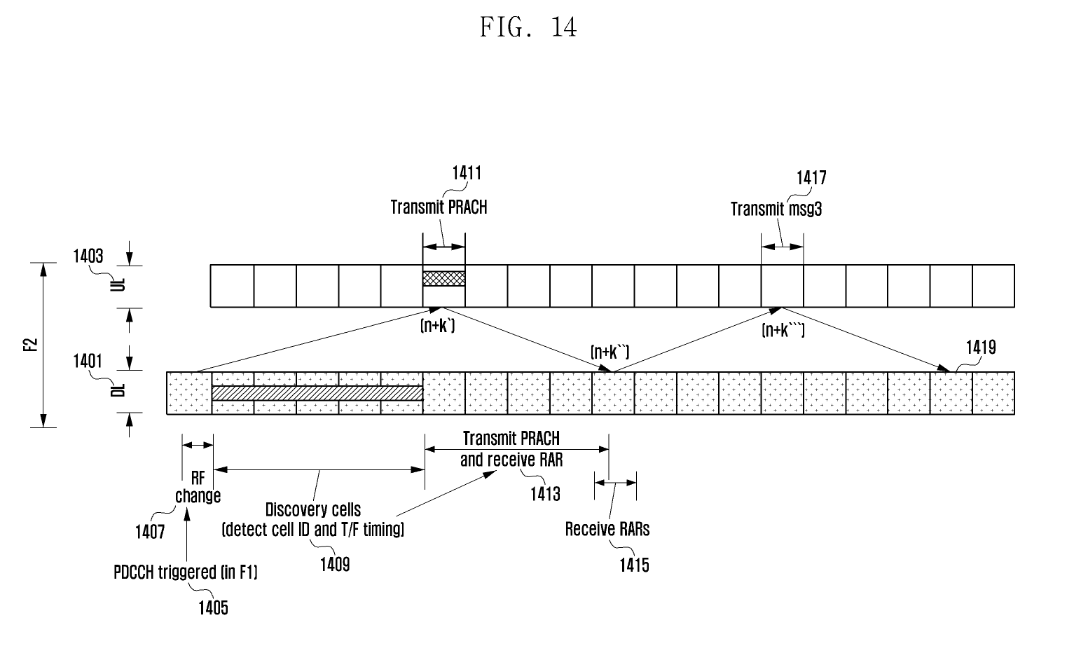

FIG. 14 is a diagram illustrating an operation of accessing a found base station at a terminal in an FDD system according an embodiment of the present invention.

Referring to FIG. 14, in the FDD system, the terminal is connected to the first base station at the first frequency band (F1) and performs a base station discovery and access at the second frequency band. Especially, FIG. 14 shows an example of further accessing a single base station.

Specifically, the terminal can transmit and receive data through the existing connection with the first base station at the first frequency band (F1). In this case, for further access to a base station at the second frequency band (F2), the first base station may transmit a control channel 1405 through the n-th subframe for a base station discovery and PRACH transmission. Then the terminal receiving the control channel 1405 may turn on an RF device for receiving the second frequency band and perform a base station discovery on downlink during the length of a specific subframe as indicated by 1409. The discovery information may include information for identifying base stations and time and frequency synchronization information about each base station. Such information may be stored in a memory of the terminal. After k′ pieces of subframes from the reception of the control channel, the terminal may transmit PRACH 1411 on uplink 1403 of the second frequency band (F2). Thereafter, based on the base station discovery information, the terminal may receive RAR 1415 at the (n+k″)-th subframe. When the RAR 1415 is successfully received, the terminal may configure a data channel from the new, second base station at the second frequency band by transmitting a signal for requesting a data channel to the second base station at the (n+k′″)-th subframe and then receiving a response 1419. Therefore, the terminal can receive data channels from different base stations at the first and second frequency bands.

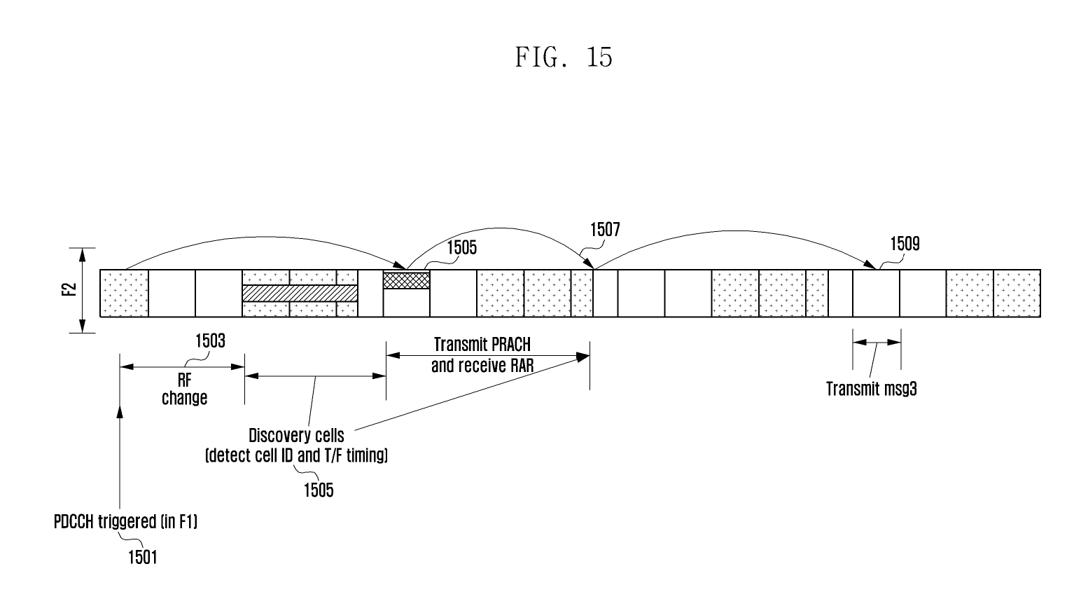

FIG. 15 is a diagram illustrating an operation of accessing a found base station at a terminal in a TDD system according an embodiment of the present invention.

Referring to FIG. 15, in the TDD system, the terminal is connected to the first base station at the first frequency band (F1) and performs a base station discovery and access at the second frequency band (F2). Especially, FIG. 15 shows an example of further accessing a single base station.

Specifically, the terminal can transmit and receive data through the existing connection with the first base station at the first frequency band (F1). In this case, for further access to a base station at the second frequency band (F2), the first base station may transmit a control channel 1501 through the n-th subframe for a base station discovery and PRACH transmission. Then the terminal receiving the control channel 1501 may turn on 1503 an RF device for receiving the second frequency band (F2) and perform a base station discovery through downlink subframe during the length of a specific subframe as indicated by 1505. The discovery information may include information for identifying base stations and time and frequency synchronization information about each base station. Such information may be stored in a memory of the terminal. At the earliest PRACH resource region after k′ pieces of subframes from the reception of the control channel, the terminal may transmit PRACH through uplink subframe 1505 of the second frequency band (F2). Thereafter, based on the base station discovery information, the terminal may receive RAR at the (n+k″)-th subframe. In case of successful reception 1507, the terminal may configure a data channel from the new, second base station at the second frequency band (F2) by transmitting a signal for requesting a data channel to the second base station at the (n+k′″)-th subframe and then receiving a response 1509. Therefore, the terminal can receive data channels from different base stations at the first and second frequency bands. In the TDD system, k′, k″ and k′″ comply with transmission timing based on the configuration of each TDD system, and FIG. 15 shows an example thereof.

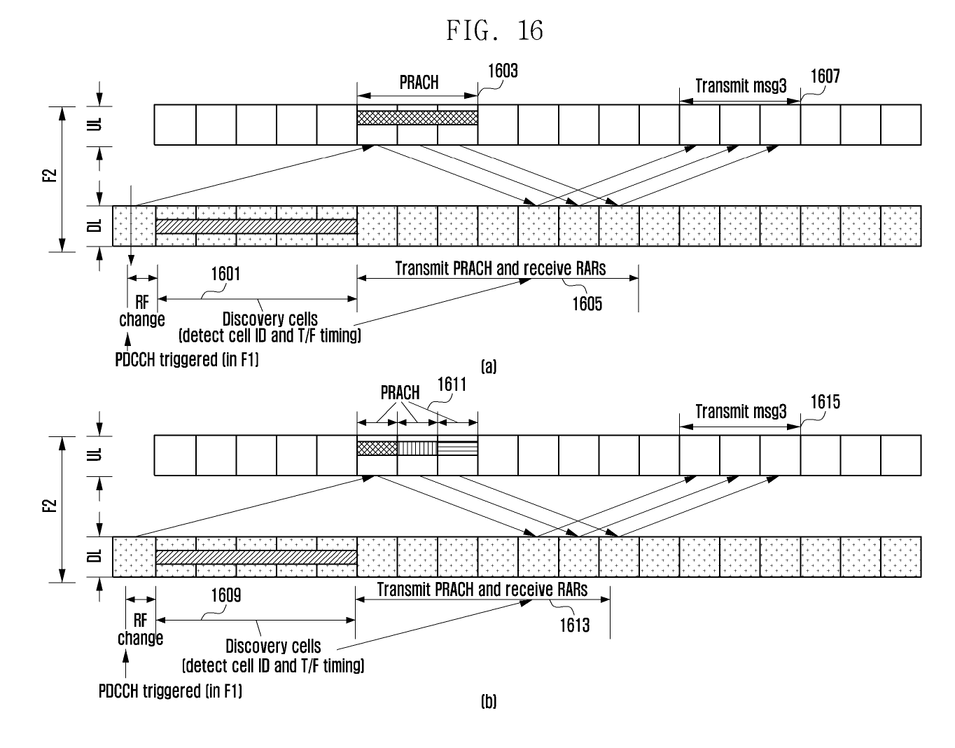

FIG. 16 is a diagram illustrating an operation of accessing several found base stations at a terminal in an FDD system according an embodiment of the present invention.

Referring to FIG. 16, in the FDD system, the terminal is connected to the first base station at the first frequency band (F1) and performs a base station discovery and access at the second frequency band (F2). Especially, FIG. 16 shows an example of further accessing a plurality of base stations.

Specifically, the terminal can transmit and receive data through the existing connection with the first base station at the first frequency band (F1). In this case, for further access to a base station at the second frequency band (F2), the first base station may transmit a control channel through the n-th subframe for a base station discovery and PRACH transmission. Then the terminal receiving the control channel may turn on an RF device for receiving the second frequency band (F2) and perform a base station discovery on downlink during the length of a specific subframe as indicated by 1601 or 1609. The discovery information may include information for identifying base stations and time and frequency synchronization information about each base station. Such information may be stored in a memory of the terminal. After k′ pieces of subframes from the reception of the control channel, the terminal may transmit PRACH 1603 through subframe having a specific length on uplink 1603 of the second frequency band (F2) so as to support a multiple base station access as shown in section (a) of FIG. 16. Alternatively, as shown in section (b) of FIG. 16, the terminal may transmit different PRACHs 1611 through different subframes. Thereafter, based on the base station discovery information, the terminal may try to receive RARs 1605 and 1613 at sequential subframes after the (n+k″)-th subframe. When the RARs 1605 and 1613 are successfully received, the terminal may configure a data channel from a new base station at the second frequency band (F2) by transmitting a signal for requesting a data channel to base stations at sequential subframes after the (n+k′″)-th subframe and then receiving responses 1607 and 1615. Therefore, the terminal can receive data channels from different base stations at the first and second frequency bands.

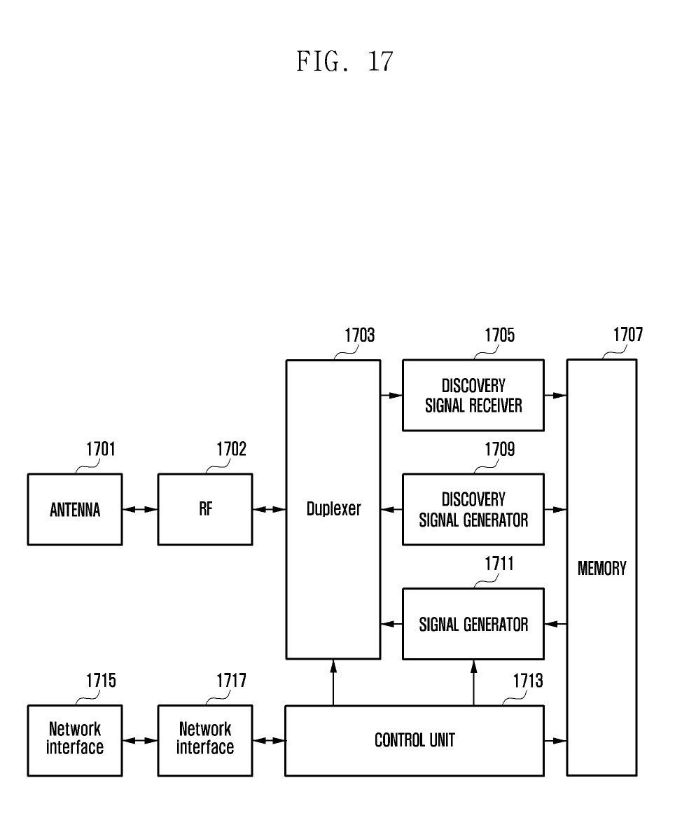

FIG. 17 is a diagram illustrating device elements of a base station according to an embodiment of the present invention.

Referring to FIG. 17, an internal structure of the base station for a multiple base station access proposed in an embodiment of this disclosure is shown in a block diagram of FIG. 17. The base station may include a control unit 1713 and a communication unit for communication with other base stations and terminals. The communication unit may include, but not limited to, network interfaces 1715 and 1717, an antenna 1701, a discovery signal generator 1709, a discovery signal receiver 1705, a signal generator 1711, and the like. The control unit 1713 of the base station controls the base station to perform one of the above-discussed embodiments. For example, the base station control unit 1713 may exchange information with neighboring base stations through communication between the network interfaces 1715 and 1717 and store this in a memory 1707. The base station control unit 1713 may control the signal generator 1711 to generate and transmit a control channel and a data channel for scheduling a terminal and also control the signal receiver 1705 to receive a data channel and a control channel from a terminal. The base station control unit 1713 may control the discovery signal generator 1709 to generate a discovery signal through PRACH notified by neighboring base stations and discovery information, control the duplexer 1703 to multiplex the discovery signal, control an RF unit 1702 to create a desired RF band signal, and control the antenna 1701 to transmit the signal to a terminal.

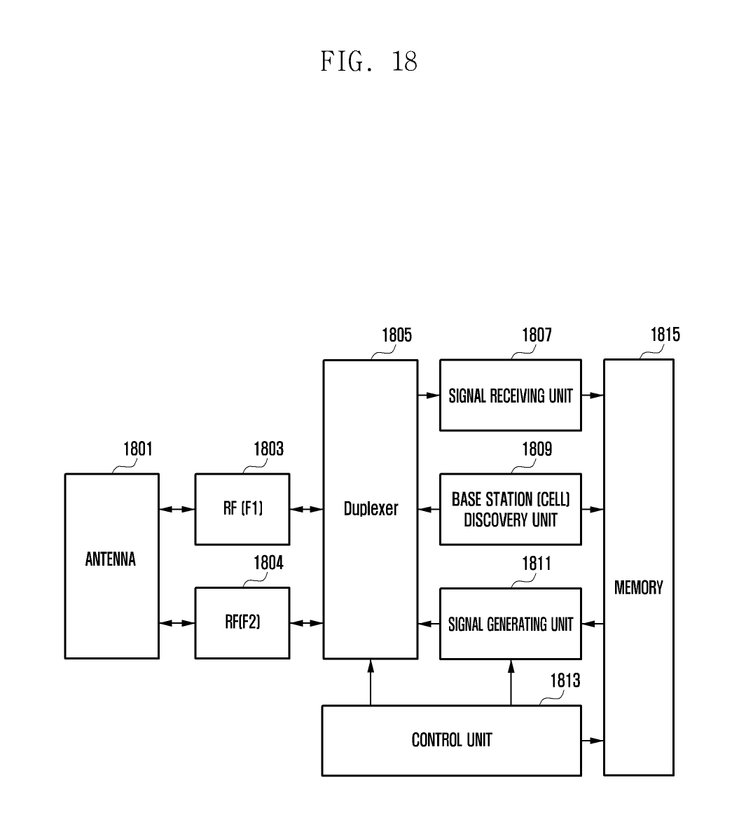

FIG. 18 is a diagram illustrating device elements of a terminal according to an embodiment of the present invention.

Referring to FIG. 18, an internal structure of the terminal for a multiple base station access proposed in an embodiment of this disclosure is shown in a block diagram of FIG. 18. The terminal may include a control unit 1813 and a communication unit for communication with base stations. The communication unit may include, but not limited to, an antenna 1801, a signal receiving unit 1807, a signal generating unit 1811, a base station discovery unit 1809, and the like. The control unit 1813 of the terminal controls the terminal to perform one of the above-discussed embodiments. For example, the terminal control unit 1813 may be connected to a base station at the first frequency band 1803 through the antenna 1801, control the signal receiving unit 1807 to receive a signal transmitted by a base station and separated through a duplexer 1805, and control the signal generating unit 1811 to generate a signal to be transmitted to a base station. If there is a need for access to a base station at the second frequency band 1804, the terminal may be instructed to discover a base station through a control channel from the currently accessed base station. Then the terminal may activate the second frequency band 1804 and store, in a memory 1815, base station discovery information obtained through the base station discovery unit 1809 and time/frequency synchronization information. Thereafter, the terminal may perform PRACH transmission through the signal generating unit 1811 and then transmit or receive a signal required for access to a new base station.

The present invention may be embodied in many different forms and should not be construed as limited to the embodiments set forth herein. Rather, the disclosed embodiments are provided so that this disclosure will be thorough and complete, and will fully convey the scope of this invention to those skilled in the art. The principles and features of the present invention may be employed in varied and numerous embodiments without departing from the scope of the invention. Accordingly, it should be apparent to those skilled in the art that this description is provided for illustration purpose only and not for the purpose of limiting the present invention as defined by the appended claims and their equivalents.

While this invention has been particularly shown and described with reference to an exemplary embodiment thereof, it will be understood by those skilled in the art that various changes in form and details may be made therein without departing from the spirit and scope of this invention as defined by the appended claims.

1. A communication method of a base station, the method comprising steps of:
delivering, to a terminal connected to the base station and to at least one neighboring second base station, information for a connection between the second base station and the terminal;
transmitting a second base station discovery command to the terminal; and
transmitting a transmission command of a base station access signal to the terminal.

2. The method of claim 1, wherein the step of transmitting the transmission command of the base station access signal includes:
receiving second base station discovery information from the terminal; and
transmitting the transmission command of the base station access signal to the terminal by using the received second base station discovery information.

3. The method of claim 1, wherein the step of transmitting the transmission command of the base station access signal includes:
receiving, from the terminal, a connection request signal including information about the second base station to be connected by the terminal; and
transmitting, to the terminal, the transmission command of the base station access signal for accessing the second base station by using the received connection request signal.

4. The method of claim 1, further comprising steps of:
temporarily allocating a network connection to the at least one second base station;
receiving a network connection confirmation message from the second base station which receives the base station access signal from the terminal;
receiving, from the terminal, information about a base station which fails to receive the base station access signal; and
releasing the temporarily allocated network connection from the base station which fails to receive the base station access signal.

5. The method of claim 1, further comprising step of:
receiving, from the terminal, a further connection result between the terminal and the second base station.

6. The method of claim 1, wherein the information for a connection between the second base station and the terminal includes identification information about the second base station, discovery signal transmission information of the second base station, identification information about the terminal, and transmission information of the base station access signal of the terminal.

7. A communication method of a terminal, the method comprising steps of:
receiving, from a connected first base station, information for a connection between at least one neighboring second base station and the terminal;
receiving a discovery signal of the at least one second base station by using the information for a connection between the second base station and the terminal; and
transmitting a base station access signal to the at least one second base station by using the information for a connection between the second base station and the terminal.

8. The method of claim 7, wherein the step of transmitting the base station access signal includes:
transmitting the discovery signal of the second base station to the first base station;
receiving a transmission command of the base station access signal from the first base station; and
transmitting the base station access signal to the second base station.

9. The method of claim 7, wherein the step of transmitting the base station access signal includes:
transmitting, to the first base station, information about the second base station to be connected by the terminal, by using the discovery signal of the second base station;
receiving, from the first base station, a transmission command of the base station access signal for accessing the second base station; and
transmitting the base station access signal to the second base station.

10. The method of claim 7, wherein the step of receiving the discovery signal includes:
changing a receiver frequency of the terminal; and
receiving the discovery signal of the second base station by using the changed frequency.

11. The method of claim 7, further comprising step of:
transmitting, to the first base station, information about the second base station which receives the base station access signal.

12. The method of claim 7, wherein the information for a connection between the second base station and the terminal includes identification information about the second base station, discovery signal transmission information of the second base station, identification information about the terminal, and transmission information of the base station access signal of the terminal.

13. The method of claim 7, further comprising steps of:
receiving an access response signal from the second base station which receives the base station access signal;
transmitting a network access request signal to the second base station which transmits the access response signal; and
receiving a network access approval signal from the second base station.

14. The method of claim 13, wherein if there are two or more of the second base stations, the access response signal is received from the second base stations through different subframes.

15. The method of claim 13, wherein if there are two or more of the second base stations, the base station access signal is transmitted to the second base stations through different subframes, and the access response signal is received from the second base stations through different subframes.

16. A base station comprising:
a communication unit configured to communicate with terminals and neighboring second base stations; and
a control unit configured to control delivering, to a terminal connected to the base station and to at least one neighboring second base station, information for a connection between the second base station and the terminal, transmitting a second base station discovery command to the terminal, and transmitting a transmission command of a base station access signal to the terminal.

17. The base station of claim 16, wherein the control unit is further configured to control receiving second base station discovery information from the terminal, and transmitting the transmission command of the base station access signal to the terminal by using the received second base station discovery information.

18. The base station of claim 16, wherein the control unit is further configured to control receiving, from the terminal, a connection request signal including information about the second base station to be connected by the terminal, and transmitting, to the terminal, the transmission command of the base station access signal for accessing the second base station by using the received connection request signal.

19. The base station of claim 16, wherein the control unit is further configured to control temporarily allocating a network connection to the at least one second base station, receiving a network connection confirmation message from the second base station which receives the base station access signal from the terminal, receiving, from the terminal, information about a base station which fails to receive the base station access signal, and releasing the temporarily allocated network connection from the base station which fails to receive the base station access signal.

20. The base station of claim 16, wherein the control unit is further configured to control receiving, from the terminal, a further connection result between the terminal and the second base station.

21. The base station of claim 16, wherein the information for a connection between the second base station and the terminal includes identification information about the second base station, discovery signal transmission information of the second base station, identification information about the terminal, and transmission information of the base station access signal of the terminal.

22. A terminal comprising:
a communication unit configured to communicate with second base stations; and
a control unit configured to control receiving, from a connected first base station, information for a connection between at least one neighboring second base station and the terminal, receiving a discovery signal of the at least one second base station by using the information for a connection between the second base station and the terminal, and transmitting a base station access signal to the at least one second base station by using the information for a connection between the second base station and the terminal.

23. The terminal of claim 22, wherein the control unit is further configured to control transmitting the discovery signal of the second base station to the first base station, receiving a transmission command of the base station access signal from the first base station, and transmitting the base station access signal to the second base station.

24. The terminal of claim 22, wherein the control unit is further configured to control transmitting, to the first base station, information about the second base station to be connected by the terminal, by using the discovery signal of the second base station, receiving, from the first base station, a transmission command of the base station access signal for accessing the second base station, and transmitting the base station access signal to the second base station.

25. The terminal of claim 22, wherein the control unit is further configured to control changing a receiver frequency of the terminal, and receiving the discovery signal of the second base station by using the changed frequency.

26. The terminal of claim 22, wherein the control unit is further configured to control transmitting, to the first base station, information about the second base station which receives the base station access signal.

27. The terminal of claim 22, wherein the information for a connection between the second base station and the terminal includes identification information about the second base station, discovery signal transmission information of the second base station, identification information about the terminal, and transmission information of the base station access signal of the terminal.

28. The terminal of claim 22, wherein the control unit is further configured to control receiving an access response signal from the second base station which receives the base station access signal, transmitting a network access request signal to the second base station which transmits the access response signal, and receiving a network access approval signal from the second base station.

29. The terminal of claim 28, wherein if there are two or more of the second base stations, the control unit is further configured to control receiving the access response signal from the second base stations through different subframes.

30. The terminal of claim 28, wherein if there are two or more of the second base stations, the control unit is further configured to control transmitting the base station access signal to the second base stations through different subframes, and receiving the access response signal from the second base stations through different subframes.
